(19) United States
(12) Patent Application Publication
(10) Pub. No.: US 2004/0141699 A1
(43) Pub. Date: Jul. 22, 2004

(54) Optical module

(76) Inventor: Masahiro Sato, Yokohama-shi (JP)

Correspondence Address: MCDERMOTT WILL & EMERY, 600 13TH STREET, N.W., WASHINGTON, DC, 20005-3096, US

(21) Appl. No.: 10/696,565

(22) Filed: Oct. 30, 2003

(30) Foreign Application Priority Data
Oct. 30, 2002 (JP) P2002-316292

(51) Int. Cl. G02B 6/42

(52) U.S. Cl. 385/93; 385/92

(57) ABSTRACT

An optical module capable of monitoring front light from a semiconductor light-emitting device by use of a semiconductor light-receiving device is provided the optical module comprises a semiconductor light-emitting device and a semiconductor light-receiving device. The semiconductor light-emitting device has a light-emitting surface for emitting light. The semiconductor light-receiving device has a light incident surface, a light-absorbing layer, and a light-emitting surface. The light incident surface receives the light emitted from the light-emitting surface of the light-emitting device. The light-absorbing layer absorbs a part of the light incident from the light incident surface. The light-emitting surface of the semiconductor light-receiving device emits the light transmitted through the light-absorbing layer. The optical module outputs the light emitted from the light-emitting surface of the semiconductor light-receiving device.

### BACKGROUND OF THE INVENTION

1. Field of the Invention

The present invention relates to an optical module.

2. Description of the Related Art

An optical module includes a semiconductor laser and a photodiode for monitoring light from the semiconductor laser. The photodiode is positioned so as to receive light emitted from a rear surface of the semiconductor laser device. The photodiode outputs a photocurrent according to intensity of the light thus received. Light from a front surface of the semiconductor laser is controlled based on the photocurrent.

However, in the semiconductor laser, the ratio of the light from the front surface to the light from the rear surface varies widely. Therefore, in order to accurately control the optical output of the semiconductor laser, desired is an optical module capable of monitoring the light from the front surface of the semiconductor laser by a photodiode.

### SUMMARY OF THE INVENTION

It is an object of the present invention to provide the optical module capable of monitoring the light from the front surface of the semiconductor laser by a photodiode.

According to one aspect of the present invention, the optical module comprises a semiconductor light-emitting device and a semiconductor light-receiving device. The semiconductor light-emitting device has a light-emitting surface for emitting light. The semiconductor light-receiving device has a light incident surface, a light-absorbing layer, and a light-emitting surface. The light incident surface receives the light emitted from the light-emitting surface of the light-emitting device. The light-absorbing layer absorbs a part of the light incident from the light incident surface. The light-emitting surface of the semiconductor light-receiving device emits the light transmitted through the light-absorbing layer. The optical module outputs the light emitted from the light-emitting surface of the semiconductor light-receiving device.

According to the above-described optical module, the semiconductor light-receiving device can absorb a portion of the light from the semiconductor light-emitting device and can emit the rest portion of the light. Therefore the optical module can monitor the light emitted from the front surface of the semiconductor light-emitting device by the light-receiving device.

The foregoing object and other objects, characteristics and advantages of the present invention will become apparent more easily from the following detailed description of the preferred embodiments of the present invention with reference to the accompanying drawings.

### BRIEF DESCRIPTION OF THE DRAWINGS

FIGS. 1A and 1B are views schematically showing optical coupling between a semiconductor light-emitting device, a semiconductor light-receiving device and an optical fiber in an optical module according to an embodiment of the present invention.

FIG. 2A is a partially exploded perspective view showing the semiconductor light-receiving device.

FIG. 2B is a partially exploded perspective view showing the semiconductor light-receiving device, which shows a state where the semiconductor light-receiving device is viewed from a direction opposite to that of FIG. 2A.

FIGS. 3A to 3C are views schematically showing other modes of optical coupling between the semiconductor light-emitting device, the semiconductor light-receiving device and the optical fiber.

FIG. 4A is a view showing a mounting part and the semiconductor light-receiving device.

FIG. 4B is a view showing the semiconductor light-receiving device mounted on the mounting part.

FIG. 4C is a view showing a light incident surface of the semiconductor light-receiving device.

FIG. 5A is a view showing a modified example of a second mounting part and a second semiconductor light-receiving device.

FIG. 5B is a view showing a light incident surface of the second semiconductor light-receiving device and a light incident surface of the second mounting part.

FIG. 5C is a view showing the second semiconductor light-receiving device mounted on the second mounting part.

FIGS. 6A to 6E are views illustrating other modes of the optical coupling between the semiconductor light-emitting device, the semiconductor light-receiving device and the optical fiber.

FIG. 7 is a longitudinal cross-section of an optical module according to an embodiment.

FIG. 8 is a perspective view showing a semiconductor light-emitting device and a semiconductor light-receiving device which are mounted on a mounting part.

FIG. 9 is a longitudinal cross-section of an optical module according to another embodiment.

FIG. 10 is a perspective view showing a semiconductor light-emitting device and a semiconductor light-receiving device which are mounted on a mounting part.

FIG. 11 is a view showing constituent components of an optical module according to another embodiment.

FIG. 12 is a view showing the optical module according to the embodiment.

FIG. 13 is a cross-sectional view along the line XIII-XIII in FIG. 12.

FIG. 14 is a view showing a modified example of an optical module.

### DESCRIPTION OF THE PREFERRED EMBODIMENTS

With reference to the drawings, an optical module according to embodiments of the present invention will be described. The same constituent components are denoted by the same reference numerals.

### First Embodiment

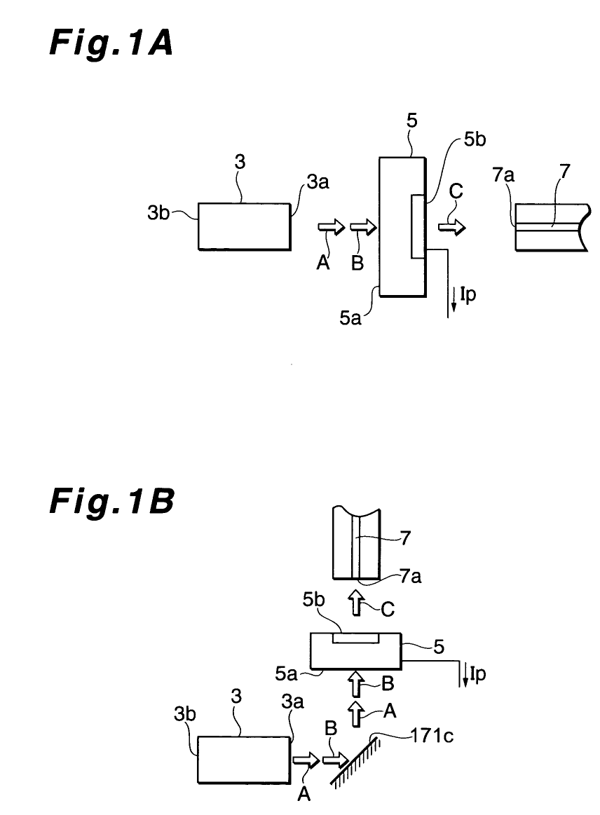

FIGS. 1A and 1B are views schematically showing optical coupling between a semiconductor light-emitting device, a semiconductor light-receiving device and an optical fiber in an optical module according to an embodiment of the present invention.

As shown in FIG. 1A, the semiconductor light-emitting device 3 has a first surface 3a and a second surface 3b. Reflectivity of the first surface 3a is smaller than that of the second surface 3b. Light is emitted from the first surface 3a. As the semiconductor light-emitting device 3, a semiconductor laser, a semiconductor optical modulator and a semiconductor optical device in which a semiconductor laser and a semiconductor modulator are integrated on a single substrate, are considered.

The semiconductor light-receiving device 5 has a light incident surface 5a and a light-emitting surface 5b. The light incident surface 5a is optically coupled to the first surface 3a of the semiconductor light-emitting device 3. The light-emitting surface 5b emits light entering into the light incident surface 5a. The optical fiber 7 receives light from the first surface 3a of the semiconductor light-emitting device 3 via the semiconductor light-receiving device 5.

With reference to FIG. 1A, light A and B from the first surface 3a of the semiconductor light-emitting device 3 enter into the semiconductor light-receiving device 5. The light B is absorbed by the semiconductor light-receiving device 5 and converted into a photocurrent Iₚ. The light A transmits through the semiconductor light-receiving device 5 and becomes light C. The light C arrives at one end 7a of the optical fiber 7.

As shown in FIG. 1B, the semiconductor light-receiving device 5 can receive the light emitted from the first surface 3a of the semiconductor light-emitting device 3 via a reflecting surface 171c. The reflecting surface 171c is optically coupled to the first surface 3a and the light incident surface of the semiconductor light-receiving device 5.

With reference to FIG. 1B, an optical path of the light emitted from the first surface 3a is bent by the reflecting surface 171c. The light bent by the reflecting surface 171c is guided to the light incident surface 5a. Light B arrived at the semiconductor light-receiving device 5 is absorbed by the semiconductor light-receiving device 5 and converted into a photocurrent Iₚ. Light A arrived at the semiconductor light-receiving device 5 transmits through the semiconductor light-receiving device 5 and becomes light C. The light C arrives at the one end 7a of the optical fiber 7.

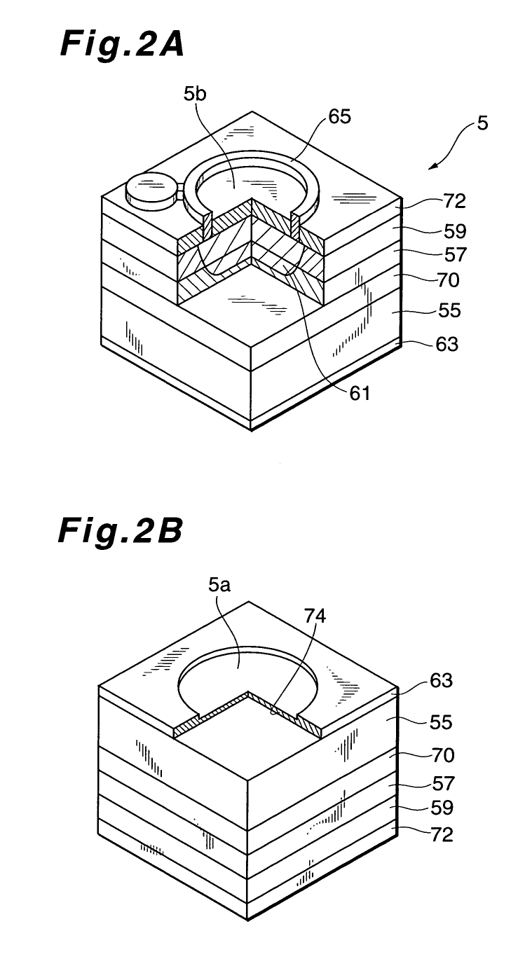

As the semiconductor light-receiving device 5 shown in FIGS. 1A and 1B, a photodiode is exemplified. FIG. 2A is a partially exploded perspective view showing the semiconductor light-receiving device 5. FIG. 2B is a partially exploded perspective view showing the semiconductor light-receiving device 5, which is viewed from a direction opposite to that of FIG. 2A.

The semiconductor light-receiving device 5 has the light incident surface 5a and the light-emitting surface 5b. The semiconductor light-receiving device 5 includes: a semiconductor substrate 55; a buffer layer 70 provided on the substrate 55; a light-absorbing layer 57 provided on the buffer layer 70; a cap layer 59 provided on the light-absorbing layer 57; a passivation film 72 provided on the cap layer 59; and a semiconductor region 61 provided in the light-absorbing layer 57 and the cap layer 59.

The semiconductor substrate 55 is highly doped with impurities of a first conductivity type. The semiconductor substrate 55 may be InP. The buffer layer 70 may be InP, too.

In the region 61, high-concentration impurities of a second conductivity type are diffused. The region 61 includes Zn as a dopant. The semiconductor substrate 55 functions as one of an anode and a cathode, and the region 61 functions as the other thereof.

The light-absorbing layer 57 and the cap layer 59 are made of non-doped semiconductors. The light-absorbing layer 57 may be the same III-V compound semiconductor as an active layer of the semiconductor light-emitting device 3. As this III-V compound semiconductor, InGaAs is exemplified. The cap layer 59 is made of InP. An amount of the light which is absorbed by the layers except the light-absorbing layer 57 is very small. The semiconductor light-receiving device 5 may be formed on InP substrate.

Transmittance T of light in the light-absorbing layer 57 is expressed by the following equation (1). In the equation, α is an absorption coefficient of the light-absorbing layer 57 and is order of 10⁴ cm⁻¹, d is a thickness of the light-absorbing layer 57.

T∝exp(−α·d) (1)

The thickness d of the light-absorbing layer 57 is determined so that desired transmittance T from the equation (1) can be obtained. For example, in case of absorbing 10%, a thickness of light-absorbing layer 57 is about 200 nm. In case of absorbing 20%, the thickness is about 200 nm. The thickness of the light-absorbing layer 57 can be a thickness so that an amount of the light necessary and sufficient to control an optical output of the semiconductor light-emitting device 3 is absorbed.

On the light incident surface 5a, an electrode 63 is provided. This electrode 63 has an opening through which light from the semiconductor light-emitting device 3 passes. In this opening, an anti-reflective film 74 for preventing reflection of light from the first surface 3a is provided.

On the light-emitting surface 5b, an electrode 65 is provided. In the passivation film 72, a ring-shaped opening extended to the semiconductor region 61 is provided. The electrode 65 is provided along this opening. Consequently, the electrode 65 has a shape having an opening through which the light transmitted through the absorbing layer 57 passes. The passivation film 72 is made of SiON.

The electrode 63 is aligned with the electrode 65. Because of this alignment, a part of the light from the first surface 3a passes through the semiconductor light-receiving device 5 and arrives at the one end 7a of the optical fiber 7.

### Second Embodiment

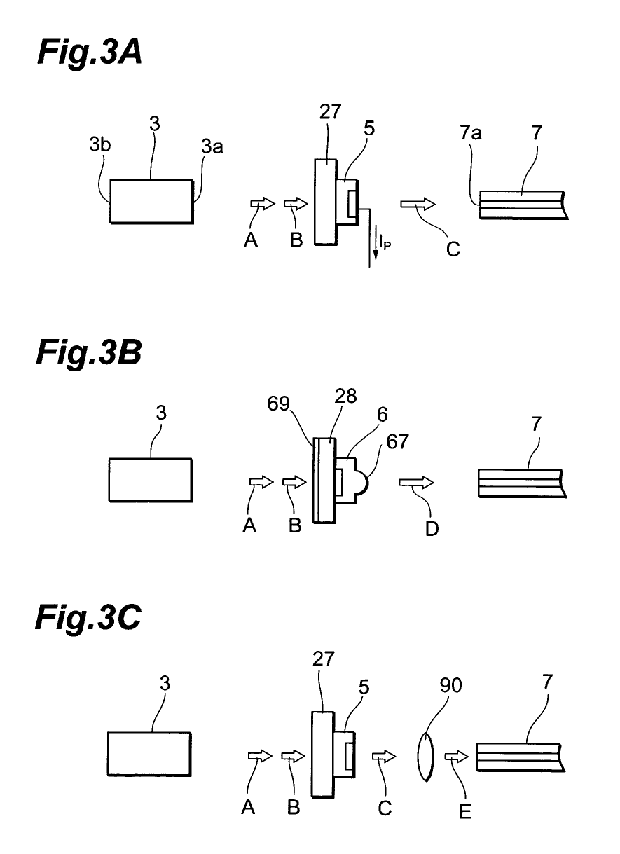

FIGS. 3A, 3B, and 3C are views schematically showing other configurations of optical coupling between the semiconductor light-emitting device, the semiconductor light-receiving device and the optical fiber.

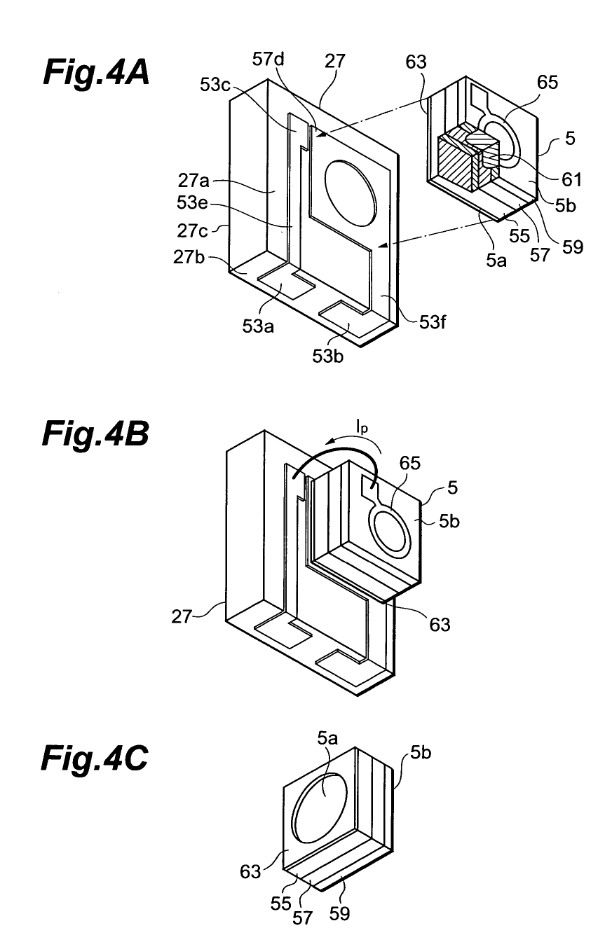

In FIG. 3A, the semiconductor light-receiving device 5 is mounted on a sub-mount 27. FIG. 4A is a view showing the sub-mount and the semiconductor light-receiving device. FIG. 4B is a view showing the semiconductor light-receiving device mounted on the sub-mount. FIG. 4C is a view showing the light incident surface of the semiconductor light-receiving device.

The sub-mount 27 has a light-emitting surface 27a, a side surface 27b and a light incident surface 27c. The sub-mount 27 is made of a material capable of transmitting light from the semiconductor light-emitting device 3, such as glass.

The semiconductor light-receiving device 5 is mounted on any of the light-emitting surface 27a and the light incident surface 27c. In this embodiment, the semiconductor light-receiving device 5 is mounted on the light-emitting surface 27a.

On the side surface 27b, a pair of electrodes 53a and 53b are provided. On the light-emitting surface 27a, a pair of electrodes 53c and 53d are provided. On the side surface 27b and the light-emitting surface 27a, a pair of conductive layers 53e and 53f are provided, which connect the pair of electrodes 53a and 53b with the pair of electrodes 53c and 53d, respectively. The electrode 53d is formed so as not to block light. In the configuration shown in FIG. 4A, the electrode 53d has an opening.

The semiconductor light-receiving device 5 is placed on the sub-mount 27 with a conductive adhesive. In the preferred embodiment, a thickness of the semiconductor light-receiving device 5 is 200 μm or less. Even in such thickness, a practical intensity of transmitted light can be obtained. Moreover, the thickness of the semiconductor light-receiving device 5 can be thinned to about 100 μm.

In FIG. 3B, light from the first surface 3a is guided to the optical fiber 7 via a semiconductor light-receiving device 6 having a monolithic lens 67. The semiconductor light-receiving device 6 is mounted on a sub-mount 28.

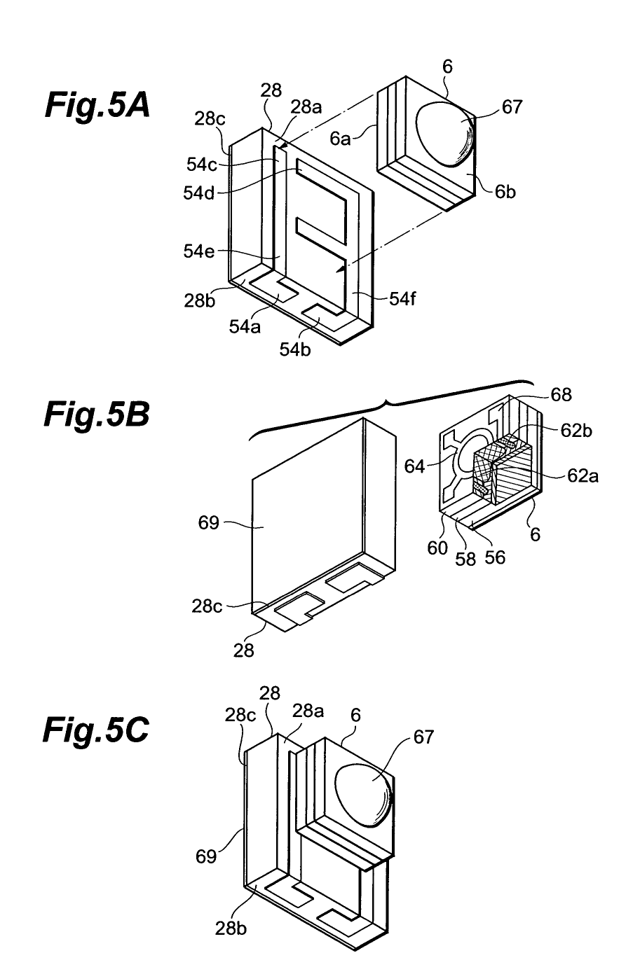

FIG. 5A is a view showing a modified example of the sub-mount 28 and the semiconductor light-receiving device. FIG. 5B is a view showing a light incident surface of the semiconductor light-receiving device and that of the sub-mount of the modified configuration. FIG. 5C is a view showing the semiconductor light-receiving device mounted on the sub-mount 28.

The sub-mount 28 has a light-emitting surface 28a, a side surface 28b and a light incident surface 28c. The sub-mount 28 is made of glass.

The configuration of the semiconductor light-receiving device 6 and the sub-mount 28 are similar to those shown in the first embodiment except that the semiconductor light-receiving device of the second embodiment has a monolithic lens.

The light-emitting surface 6b of the semiconductor light-receiving device 6 includes the monolithic lens 67. The monolithic lens 67 includes a semiconductor region projecting from the light-emitting surface 6b. The optical fiber 7 receives light from the semiconductor light-emitting device 3 via the monolithic lens 67.

On the light incident surface 6a of the semiconductor light-receiving device 6, an electrode 64 is provided. This electrode 64 has an opening through which light from the first surface 3a of the semiconductor light-emitting device 3 passes. The electrode 64 is connected to one of anode and cathode regions. On the light incident surface 6a, another electrode 68 is provided, which is connected to the other of the anode and cathode regions. The electrodes 64 and 68 are aligned with the electrodes 54c and 54d.

On the light incident surface 28c of the sub-mount 28, an anti-reflective film 69 may be further provided. The anti-reflective film 69 is provided between the light incident surface 6a of the semiconductor light-receiving device 6 and the semiconductor light-emitting device 3. By the anti-reflective film 69, light returning back to the semiconductor light-emitting device 3 is reduced.

As the anti-reflective film 69, an inorganic material containing Si such as SiON is applicable.

In FIG. 3C, a lens 90 is provided between the semiconductor light-receiving device 5 and the optical fiber 7. The lens 90 condenses the light C to provide light E. The light E reaches at the one end 7a of the optical fiber 7.

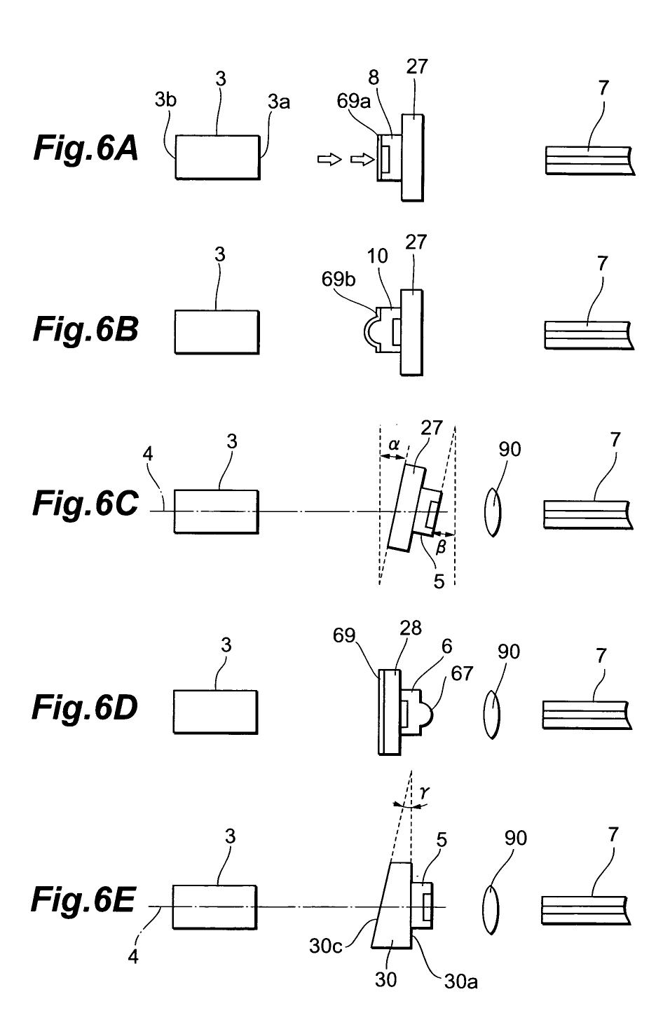

The optical coupling between the semiconductor light-emitting device, the semiconductor light-receiving device and the optical fiber is not limited to those described above. FIGS. 6A to 6E are views illustrating other configurations of the optical coupling between the semiconductor light-emitting device, the semiconductor light-receiving device and the optical fiber.

With reference to FIG. 6A, a semiconductor light-receiving device 8 has a structure of a front incident type and is mounted on the sub-mount 27. The semiconductor light-receiving device 8 is provided between the sub-mount 27 and the semiconductor light-emitting device 3. The semiconductor light-receiving device 8 is optically coupled directly to the first surface 3a of the semiconductor light-emitting device 3. On the semiconductor light-receiving device 8, an anti-reflective film 69a is provided.

With reference to FIG. 6B, a semiconductor light-receiving device 10 is a back illuminated type and is mounted on the sub-mount 27. The semiconductor light-receiving device 10 includes a monolithic lens on the back surface thereof. The monolithic lens is optically coupled directly to the first surface 3a of the semiconductor light-emitting device 3.

With reference to FIG. 6C, the semiconductor light-receiving device 5 is mounted on the sub-mount 27. In order not to return light reflected back to the semiconductor light-emitting device 3, the sub-mount 27 is inclined relative to a plane vertically intersecting an optical axis at an angle of α. As a suitable range of the angle α, more than 5 degrees and not more than 45 degree is applicable. Moreover, in order not to return light reflected back to the semiconductor light-emitting device 3, the semiconductor light-receiving device 5 is inclined relative to a face vertically intersecting an optical axis at an angle of β. As a suitable range of the angle β, more than 5 degrees and not more than 45 degree is applicable.

FIG. 6D shows a double-lens optical system. Light from the semiconductor light-emitting device 3 is transmitted to the optical fiber via the monolithic lens 67 and the lens 90.

In FIG. 6E, the semiconductor light-receiving device 5 is mounted on a sub-mount 30. The sub-mount 30 has a light-emitting surface 30a and a light incident surface 30c. The semiconductor light-receiving device 5 is mounted on the light-emitting surface 30a. The light-emitting surface 30a is inclined relative to the light incident surface 30c at an angle of γ. As a suitable range of γ, more than 5 degrees and not more than 45 degree is applicable. With the above-described dispositions, the amount of light returning back to the semiconductor light-emitting device 3 is reduced.

### Third Embodiment

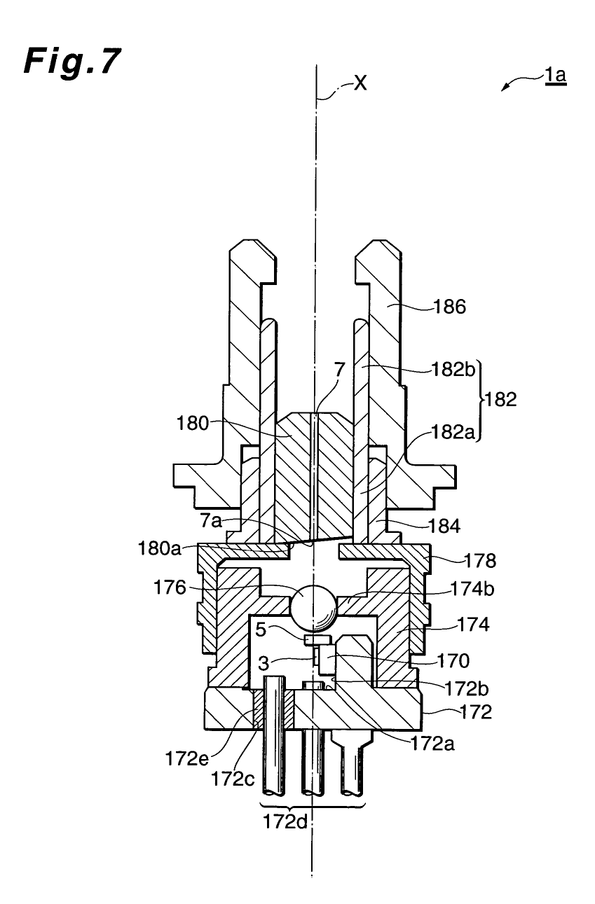

FIG. 7 is a longitudinal cross-section of an optical module 1a according to the third embodiment. The optical module 1a uses the semiconductor light-emitting device 3, the semiconductor light-receiving device 5 and the optical fiber 7, which are optically coupled as shown in FIG. 1A.

The optical module 1a is a coaxial optical module. The optical module la includes: the semiconductor light-emitting device 3; the semiconductor light-receiving device 5; the optical fiber 7; a stem 172; a chip carrier 170; a lens cap 174; a lens 176; a aligning member 178; a stub 180; a first sleeve 182; a second sleeve 184; and a third sleeve 186.

In the stem 172, a plurality of holes 172c extending in a predetermined axis X are provided. In each of the plurality of holes 172c, a lead terminal 172d is inserted. A sealing member 172e such as sealing glass fills a gap between the lead terminal 172d and an inner wall of the hole 172c.

The chip carrier 170 is supported on a second mounting surface 172b. The chip carrier 170 mounts the semiconductor light-emitting device 3 and the semiconductor light-receiving device 5 thereon.

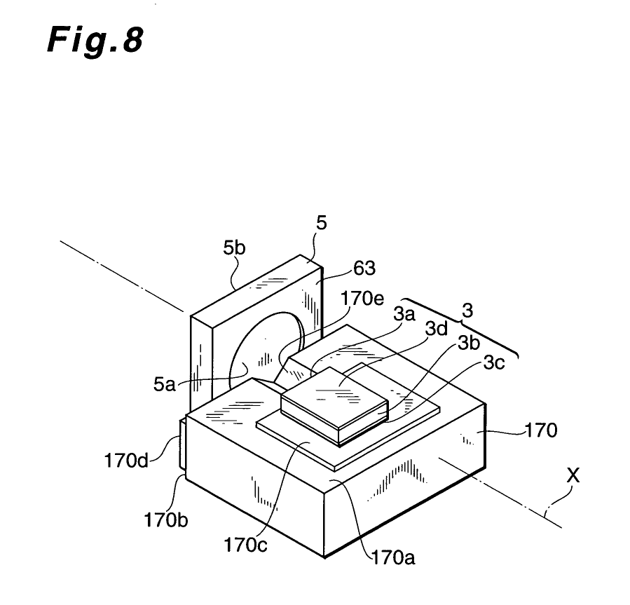

FIG. 8 is a perspective view showing the semiconductor light-emitting device 3 and the semiconductor light-receiving device 5 which are mounted on the chip carrier 170. The chip carrier 170 is made of a ceramic material such as alumina.

The chip carrier 170 has a first mounting surface 170a and a second mounting surface 170b. On the first mounting surface 170a, a conductive pattern 170c is provided. The semiconductor light-emitting device 3 is mounted on the conductive pattern 170c. One electrode 3c of the semiconductor light-emitting device 3 is electrically connected to the conductive pattern 170c. The conductive pattern 170c and the lead terminal 172d are electrically connected to each other by a bonding wire. Thus, the one electrode 3c is electrically connected to the lead terminal 172d. The other electrode 3d of the semiconductor light-emitting device 3 is electrically connected to the lead terminal 172d by another bonding wire.

The second mounting surface 170b intersects with the first mounting surface 170a. The semiconductor light-receiving device 5 is mounted on another conductive pattern 170d provided on the second mounting surface. The electrode 63 of the semiconductor light-receiving device 5 is electrically connected to this conductive pattern 170d, which is electrically connected to the lead terminal 172d by a bonding wire. The electrode 65 on the light-emitting surface 5b of the semiconductor light-receiving device 5 is electrically connected to the lead terminal 172d by the bonding wire.

In the chip carrier 170, a groove 170e is provided between the first surface 3a and the light incident surface 5a of the semiconductor light-receiving device 5 for guiding light from the first surface 3a of the semiconductor light-emitting device 3 to the light incident surface 5a of the semiconductor light-receiving device 5.

On the mounting surface 172a of the stem 172, the lens cap 174 is mounted. The lens cap 174 includes a lens holding portion 174b. The lens holding portion 174b has an opening provided therein. By inserting the lens 176 into this opening, the lens 176 is held by the lens holding portion 174b. The lens 176 condenses the light emitted from the light-emitting surface 5b and guides the light to the optical fiber 7.

The aligning member 178 is fitted on the lens cap 174. The aligning member 178 is provided to adjust a distance between the lens 176 and the optical fiber 7.

The optical fiber 7 is held at a center hole of the stub 180. One end surface 180a of the stub 180 and the one end 7a of the optical fiber 7 are inclined relative to the predetermined axis X.

The first sleeve 182, the second sleeve 184 and the third sleeve 186 are cylindrical members. The stub 180 is inserted into an inner hole of the first sleeve 182. The first sleeve 182 includes first and second portions 182a and 182b sequentially lined up. The stub 180 is fitted in the first portion 182a of the first sleeve 182.

The second portion 182b of the first sleeve 182 is for holding a ferrule which holds an optical fiber. As the ferrule is held by the second portion 182b, the optical fiber held by the ferrule is optically coupled to the optical fiber 7 in the stub 180.

The second sleeve 184 supports a base part of the first sleeve 182. The second sleeve 184 is fixed to one end of the aligning member 178.

The second sleeve 184 is inserted into an inner hole of the third sleeve 186. The third sleeve 186 is provided so as to cover the first sleeve 182.

### Fourth Embodiment

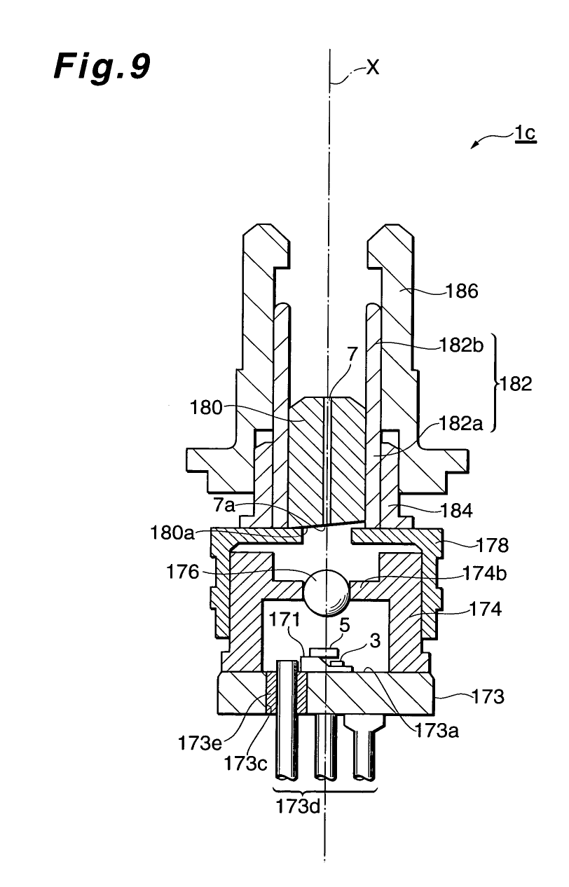

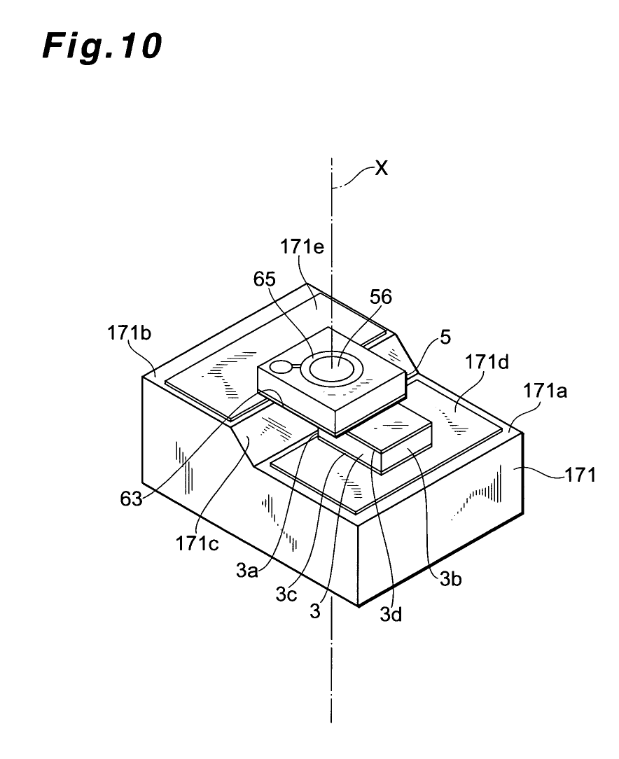

FIG. 9 is a longitudinal cross-section of an optical module 1b according to another embodiment of the present invention. FIG. 10 is a perspective view showing the semiconductor light-emitting device 3 and the semiconductor light-receiving device 5 which are mounted on a chip carrier 171. The chip carrier 171 is made of alumina.

The chip carrier 171 has a first mounting surface 171a, a second mounting surface 171b and a reflecting surface 171c. The first mounting surface 171a intersects with the predetermined axis X. The second mounting surface 171b is provided along the plane intersecting with the predetermined axis X. A level of the second mounting surface 171b is greater than a level of the first mounting surface 171a.

The semiconductor light-emitting device 3 is mounted on a conductive pattern 171d provided on the first mounting surface 171a. One electrode 3c of the semiconductor light-emitting device 3 is electrically connected to the conductive pattern 171d. The conductive pattern 171d and the lead terminal 173d are electrically connected to each other by a bonding wire. The other electrode 3d of the semiconductor light-emitting device 3 is electrically connected to the lead terminal 173d by the bonding wire.

The semiconductor light-receiving device 5 is mounted on another conductive pattern 171e provided on the second mounting surface 171b. The electrode 63 of the semiconductor light-receiving device 5 is electrically connected to the conductive pattern 171e. The conductive pattern 171e and the lead terminal 173d are electrically connected to each other by a bonding wire. The electrode 65 is electrically connected to the lead terminal 173d by the bonding wire.

The reflecting surface 171c is provided between the first and second mounting surfaces 171a and 171b. The reflecting surface 171c is inclined with respect to the predetermined axis X. The reflecting surface 171c reflects light emitted from the semiconductor light-emitting device 3 toward the light incident surface 5a of the semiconductor light-receiving device 5. A portion of the light reflected by the reflecting surface 171c is absorbed by the light-absorbing layer 57 of the semiconductor light-receiving device 5. As the light is absorbed by the light-absorbing layer 57, a photocurrent Iₚ is outputted. The other portion of the light reflected by the reflecting surface 171c is transmitted through the light-absorbing layer 57 and emitted from the light-emitting surface 5b.

### Fifth Embodiment

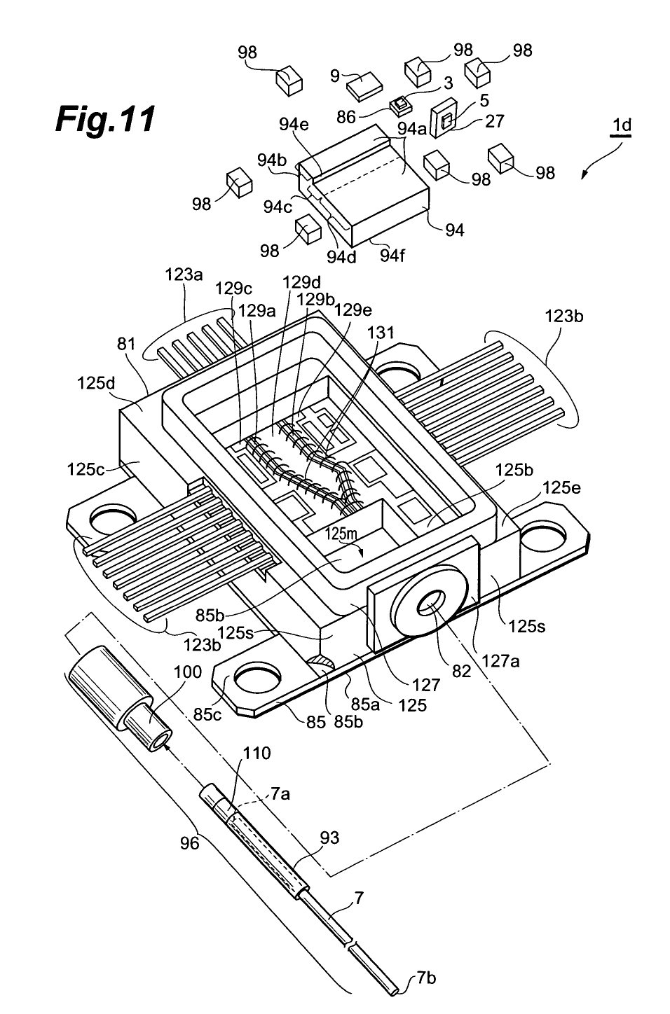

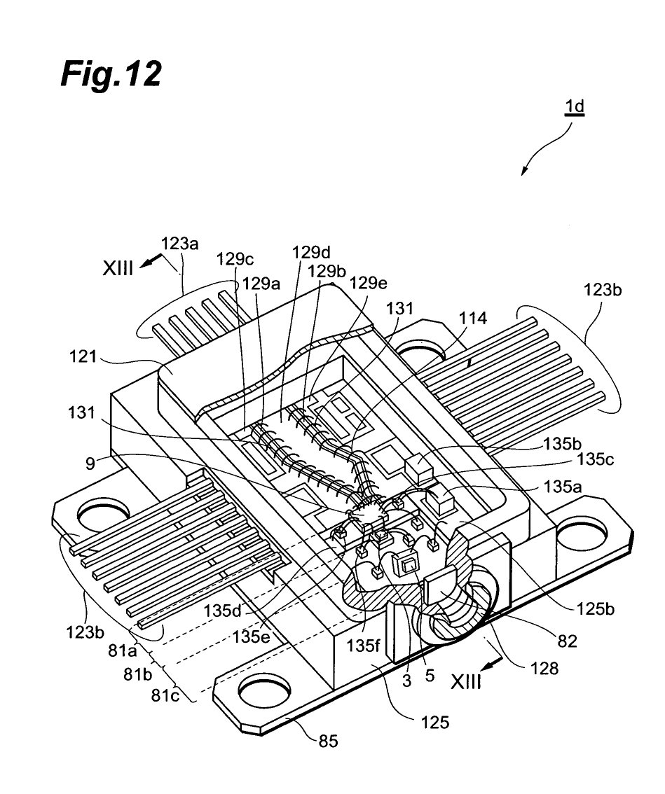

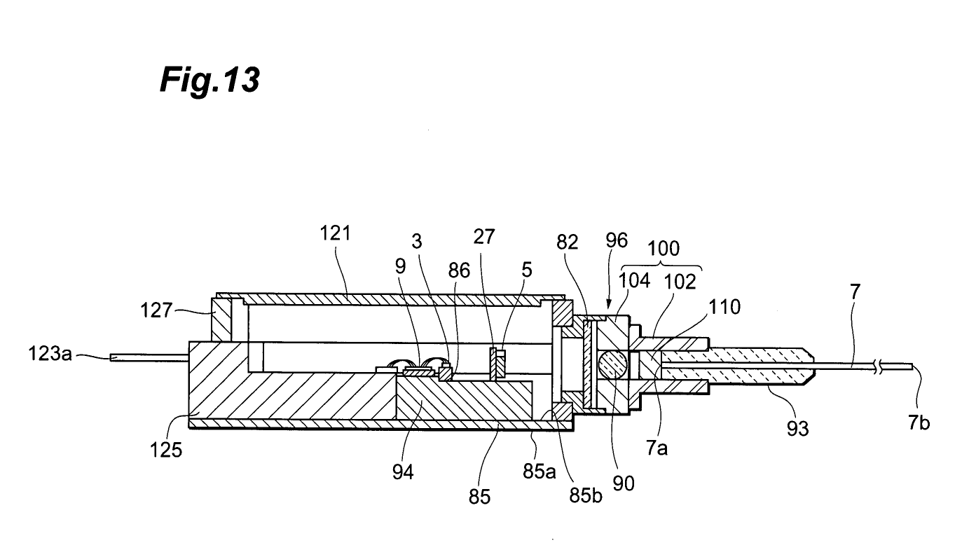

FIG. 11 is a view showing components of an optical module 1d according to another embodiment. FIG. 12 is a view showing the optical module 1d according to this embodiment. FIG. 13 is a cross-sectional view along the line XIII-XIII in FIG. 12.

The optical module 1d includes the semiconductor light-emitting device 3, the semiconductor light-receiving device 5, the driver 9, an optical window 82 and the optical fiber 7 which are optically coupled as shown in FIG. 3C. The optical window 82 is made of a material capable of transmitting light of the semiconductor light-receiving device 5.

The configuration and the structure of the semiconductor light-emitting device 3 and the semiconductor light-receiving device 5 are similar to those previously described. The optical window 82 receives light from the first surface 3a of the semiconductor light-emitting device 3 via the semiconductor light-receiving device 5.

The driver 9 drives the semiconductor light-emitting device 3. In this optical module 1d, the semiconductor light-receiving device 5 is provided between the optical fiber 7 and the semiconductor light-emitting device 3, and the semiconductor light-receiving device 5 and the driver 9 are disposed in the vicinity of the semiconductor light-emitting device 3.

The optical module 1d further include a housing 81. The housing 81 comprises a base 85, a lid 121, a first sidewall 125 and a second sidewall 127.

In this optical module 1d, the semiconductor light-emitting device 3 is positioned between the semiconductor light-receiving device 5 and the driver 9. Thus, positional relation of the semiconductor light-emitting device 3 to the driver 9 is suitable to supply a high-speed signal to the semiconductor light-emitting device 3, and that of the semiconductor light-emitting device 3 to the semiconductor light-receiving device 5 is suitable for the semiconductor light-receiving device 5 to receive monitor light from the semiconductor light-emitting device 3.

The optical module 1d can further include a light-transmitting unit 96 aligned with the optical window 82 as shown in FIG. 3. The light-transmitting unit 96 includes the optical fiber 7 receiving light from the semiconductor light-emitting device 3 via the optical window 82. The optical fiber 7 is held by a ferrule 93.

The optical module 1d includes a holding member 100 for holding the ferrule 93. The holding member 100 is made of metal, for example, and is fixed to the housing 81.

The holding member 100 includes a sleeve 102 and a lens holder 104. The ferrule 93 holds the optical fiber 7, and the holding member 100 holds a lens 90, the ferrule 93 and, if necessary, an optical isolator 110.

The optical fiber 7 has one end 7a and the other end 7b. The one end 7a receives light from the semiconductor light-emitting device 3 via the semiconductor light-receiving device 5, the optical window 82 and the lens 90. The optical fiber 7 is utilized for transmitting the light received at the one 7a end to the other end 7b.

The optical window 82 can be hermetically sealed. Moreover, as shown in FIG. 13, the semiconductor light-emitting device 3 can be optically coupled to the optical fiber 7 by the single lens 90 provided between the optical fiber 7 and the semiconductor light-emitting device 3 (or the monolithic lens provided in the semiconductor light-receiving device). The lens 90 operates so as to condense light from the semiconductor light-emitting device 3 on the one end 7a of the optical fiber 7. The configuration having a single-lens system brings about several advantages. First, the number of components constituting the optical module can be reduced and thus the optical module can be miniaturized. Second, the reduced number of components not only lowers costs of the components but also shortens assembly time. For example, a double-lens system takes time in adjusting the center of the lens. Thus, the single-lens system achieves a significant effect of time saving.

The optical module 1d include a bench 94. The bench 94 has a mounting surface 94a. The semiconductor light-emitting device 3 and the semiconductor light-receiving device 5 are positioned on the mounting surface 94a, thus positioning of the semiconductor devices is easy. Since the semiconductor light-emitting device 3 and the semiconductor light-receiving device 5 are disposed on the mounting surface 94a, alignment of the optical axes thereof is simplified.

In FIG. 11, the mounting surface 94a has first to third regions 94b to 94d which are sequentially arranged along the predetermined axis. The driver 9 is positioned in the first region 94b. The semiconductor light-emitting device 3 is mounted in the second region 94c. To be more specific, a heat sink 86 is provided between the semiconductor light-emitting device 3 and the bench 94. The heat sink 86 dissipates heat generated in the semiconductor light-emitting device 3 and adjusts a level of the semiconductor light-emitting device 3.

The semiconductor light-receiving device 5 is arranged in the third region 94d. The semiconductor light-receiving device 5 is mounted on another sub-mount 27 and the sub-mount 27 is placed on the third region 94d. Since the mounting surface 94a has the first to third regions 94b to 94d, the driver 9 can be placed next to the semiconductor light-emitting device 3 and the semiconductor light-receiving device 5 can be placed next to the semiconductor light-emitting device 3.

The driver 9 and the semiconductor light-emitting device 3 are mounted on the bench 94 and thus the driver 9 and the semiconductor light-emitting device 3 can be arranged close to each other. The heat generated in the semiconductor light-emitting device 3 and the driver 9 is dissipated through the bench 94 and the base 85.

The mounting surface 94a has a step 94e between the first region 94b and the second regions 94c. The bench 94 is disposed in the housing 81 with a bottom surface 94f thereof facing to the base 85 of the housing 81. A size of the step 94e is greater than a thickness of the second region 94c. Due to the step 94e, heights of the driver 9 and the semiconductor light-emitting device 3 can be adjusted with each other. Thus a wiring length between the driver 9 and the semiconductor light-emitting device 3 can be shortened.

The mounting surface 94a also mounts some electronic devices 98 thereon, such as a die cap and a wiring post. The electronic device 98 is arranged next to the semiconductor light-emitting device 3 to operate the semiconductor light-emitting device 3 in a high-speed.

The housing 81 includes the base 85 made of metal, the lid 121 and the first and second sidewalls 125 and 127. The first and second sidewalls 125 and 127 are disposed on the base 85, which forms a cavity for enclosing the semiconductor light-receiving device, the semiconductor light-emitting device and the driver. By covering the second sidewall 127 with the lid 121, the cavity can be sealed.

The base 85 includes: an outer surface 85a for mounting the optical module 1d on a flat substrate; an inner surface 85b for mounting the bench 94 and a first sidewall 116; and a flanges 85c.

The first sidewall 125 includes sidewalls 125c to 125e and an opening 125m. The bench 94 is arranged in the opening 125m. The sidewall 125 has a front end surface 125s.

The second sidewall 127 is positioned on the first sidewall 125 so as to contact the front end surface 125s.

The first sidewall 125 also includes a wiring layer provided on a wiring surface 125b. In the first sidewall 125, electronic devices 135a to 135f, the semiconductor light-emitting device 3 and the driver 9, and lead terminals 123a and 123b can be electrically connected to each other, as shown in FIG. 12. The wiring surface 125b has a pair of wiring layers 129a and 129b in order to transmit a signal for driving the semiconductor light-emitting device 3. The wiring surface 125b has conductive layers 129c to 129e for the ground additional at both sides of the respective wiring layers 129a and 129b. The optical module 1d includes a plurality of bonding wires 131 for connecting the conductive layers 129c to 129e to the ground over the wiring layers 129a and 129b. By the configuration described above, which simulates a microstrip line or a strip line, transmitting a high-frequency signal over 10 Gbps can be realized. Thus, the housing 81 is suitable for a small-sized optical module operating at high-frequency signals.

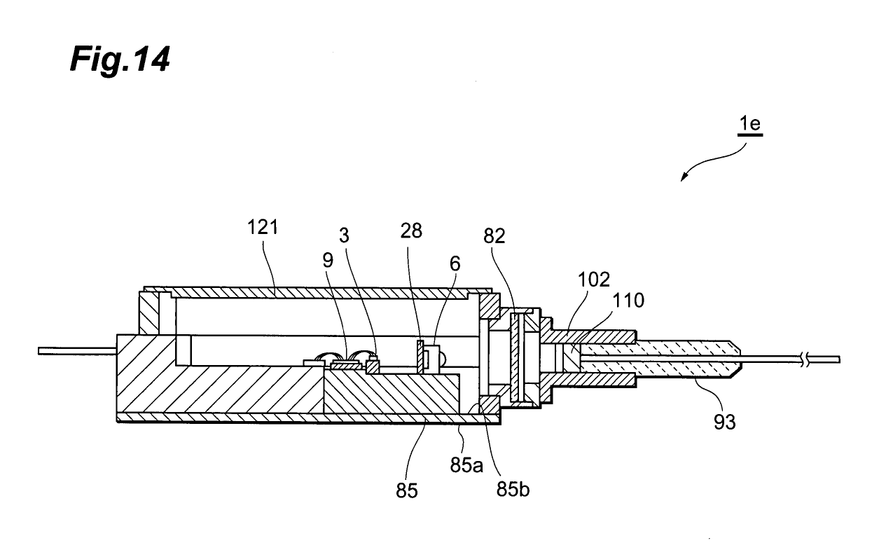

FIG. 14 is a view showing a modified example of an optical module. An optical module 1e includes a semiconductor light-receiving device 6 and a sub-mount 28 in place of the semiconductor light-receiving device 5 and the sub-mount 27 of FIG. 13. The optical module shown in FIG. 14 uses the semiconductor light-emitting device 3, the semiconductor light-receiving device 6 and the optical fiber 7 which are optically coupled as shown in FIG. 3B. The semiconductor light-receiving device 6 includes a monolithic lens and does not include the isolated lens 90. Therefore, the optical module 1e shown in FIG. 14 is the single-lens optical system.

As described above, in the optical module according to the embodiments of the present invention, the light from the first surface 3a of the semiconductor light-emitting device 3, that is, a portion of the light emitted from the front surface thereof, is absorbed by the semiconductor light-receiving device and the other portion of the light is guided to the optical fiber 7. Therefore optical output from the first surface 3a of the semiconductor light-emitting device 3 can be controlled with high accuracy.

The principle of the present invention has been described according to the preferred embodiments by use of the drawings. It is apparent to those skilled in the art that the present invention can be modified without departing from the principle. For example, the description was mainly given by taking the optical module of the single-lens system. However, the present invention can be also applied to the optical module having the double-lens system. In the present invention, the optical module may be configured to include a plurality of semiconductor light-emitting devices. Furthermore, the details of the structure of the housing can be modified as required.

What is claimed is:

1. An optical module comprising:
a semiconductor light-emitting device having a light-emitting surface for emitting light; and
a semiconductor light-receiving device having a light incident surface for receiving the light emitted from the light-emitting surface of the semiconductor light-emitting device, a light-absorbing layer for absorbing a part of the light incident from the light incident surface, and a light-emitting surface for emitting light transmitted through the light-absorbing layer,
wherein the optical module outputs the light emitted from the light-emitting surface of the semiconductor light-receiving device.

2. The optical module according to claim 1, wherein the semiconductor light-emitting device further comprises an active layer,
wherein the active layer and the light-absorbing layer include same III-V compound semiconductor.

3. The optical module according to claim 2, wherein the light-absorbing layer of the semiconductor light-receiving device is made of InGaAs.

4. The optical module according to claim 3, wherein the semiconductor light-receiving device further comprises a cap layer made of InP provided on the light-absorbing layer and a substrate made of InP.

5. The optical module according to claim 2, wherein a thickness of the light-absorbing layer is not more than 200 nm.

6. The optical module according to claim 1, further comprising an optical fiber having an end optically coupling to the light-emitting surface of the semiconductor light-receiving device,
wherein the light emitted from the light-emitting surface of the semiconductor light-receiving device is outputted through the optical fiber.

7. The optical module according to claim 6, further comprising:
a lens for condensing the light emitted from the light-emitting surface of the semiconductor light-receiving device to the end of the optical fiber;
a lens holder for holding the lens;
a stub for securing the optical fiber, the stub having an end surface and another surface, the end of the optical fiber being exposed at the end surface of the stub;
a stem for mounting the semiconductor light-emitting device and the lens holder; and
wherein the optical fiber has another end exposing at the another surface of the stub and the light emitted from the light-emitting surface of the semiconductor light-receiving device is outputted from another end of the optical fiber.

8. The optical module according to claim 7, wherein the semiconductor light-emitting device further comprises an active layer,
wherein the active layer and the light-absorbing layer include same III-V compound semiconductor.

9. The optical module according to claim 8, wherein the light-absorbing layer of the semiconductor light-receiving device is made of InGaAs.

10. The optical module according to claim 9, wherein the semiconductor light-receiving device further comprises a cap layer made of InP provided on the light-absorbing layer and a substrate made of InP.

11. The optical module according to claim 7, wherein a thickness of the light-absorbing layer is not more than 200 nm.

12. The optical module according to claim 7, further comprising an optical bench having a first surface and a second surface connected to the first surface, the semiconductor light-emitting device being disposed on the first surface and the light-receiving device being disposed on the second surface; and
a sub-mount for mounting the optical bench.

13. The optical module according to claim 7, further comprising:
an optical bench having a first surface a second surface and a third surface connecting the first surface to the second surface, the semiconductor light-emitting device being disposed on the first surface and the light-receiving surface being disposed on the second surface, the optical bench being mounted on the stem,
wherein the light emitted from the light-emitting surface of the semiconductor light-emitting device enters the light incident surface of the semiconductor light-receiving device through the third surface.

14. The optical module according to claim 1, further comprising:
an optical bench including a first region providing the semiconductor light-receiving device and a second region providing the semiconductor light-emitting device; and
a package including a base for mounting the optical bench and a first member having an optical window, the optical bench being enclosed in the package,
wherein the light emitted from the light-emitting surface of the semiconductor light-emitting device is outputted through the optical window.

15. The optical module according to claim 14, wherein the semiconductor light-emitting device further comprises an active layer,
wherein the active layer and the light-absorbing layer include same III-V compound semiconductor.

16. The optical module according to claim 15, wherein the light-absorbing layer of the semiconductor light-receiving device is made of InGaAs.

17. The optical module according to claim 16, wherein the semiconductor light-receiving device further comprises a cap layer made of InP provided on the light-absorbing layer and a substrate made of InP.

18. The optical module according to claim 14, wherein a thickness of the light-absorbing layer is not more than 200 nm.

19. The optical module according to claim 14, wherein the package further encloses a driver for electrically driving the light-emitting device, and the optical bench further including a third region for providing the driver,
wherein the first region, the second region, and the third region are arranged in this order along a predetermined axis.

20. The optical module according to claim 19, wherein the first member has a plurality of impedance-matched wiring patterns and a plurality of lead terminals,
wherein the driver is electrically connected to the lead terminals through the impedance-matched wiring patterns.
